(19) United States
(12) Patent Application Publication
(10) Pub. No.: US 2004/0113574 A1
(43) Pub. Date: Jun. 17, 2004

(54) Recovery device for mistaken operation of reeling door

(76) Inventor: Chung Hsien Hsieh, Taipei Hsien (TW)

Correspondence Address: BUCKNAM AND ARCHER, 1077 Northern Blvd., Roslyn, NY, 11576-1696, US

(21) Appl. No.: 10/317,488

(22) Filed: Dec. 12, 2002

(51) Int. Cl. H02P 3/00

(52) U.S. Cl. 318/275

(57) ABSTRACT

A recovery device for mistaken operation of a reeling door, wherein the door-reeling machine includes a motor, a brake for braking a rotary shaft which actuates the brake disc to release the brake upon motor energization. A limit switch device includes a threaded rod moving in pace with the door-reeling machine, a pair of sliding blocks on the threaded rod for actuation of limit switches at both ends thereof to control upper and lower stagnation points of the door. A sensor for detecting door reeling and cutting off power when an abnormal reeling condition is detected. A circuit for controlling motor start and stop and controlling the brake includes a feedback device. When the sensor detects an abnormal condition and cuts off power, the motor rotor reversely rotates due to uprising torque generating a counter-potential which is fed back to a coil winding of the brake to delay braking action so that the door slides downward to recover.

### BACKGROUND OF THE INVENTION

For the sake of safety, as shown in FIG. 1, latch pin device 2 is usually provided at the lateral side of conventional reeling door 1 to prevent the door from being enforced opened by external force or from being pulled up by jack device, which is used to fasten the reeling door 1 after closing of reeling door 1. Although this latch pin device 2 provides further protection for safety, opening procedure for the reeling door requires an additional procedure in which the locking by latch pin 2 should be released first so as to operate the switch 3 for the reeling door 1. At the same time, user often forgets this procedure to operate the switch 3 for the reeling door 1 before releasing the latch pin device 2, this makes the reeling door 1 lock up with the latch pin and power supply is cut off by the switching off of the safety relay. Under this situation, because neither the reeling door 1 is opened nor the latch pin 2 is released, this locking up state between the reeling door 1 and the latch pin 2 should be eliminated, i.e., the reeling door 1 should be recovered to original released state first, and then the latch pin 2 is released to allow reoperation of the switch 3 for the reeling door 1. Thus, it is desired to improve the design of conventional reeling door.

It is this problem enlightens the inventor that in ideal condition, the reeling door should has self-recovery capability to prevent itself from being locked up with the latch pin due to mistaken operation. Upon considering the linking relationship between reeling door motor and brake device, the inventor finds that if brake device can lag behind motor for short period of time to actuate upon the happening of abnormal condition and power supply being cutting off. The reeling door is rotated reversely due to the uprising torque of the rotor of motor so as to slide downwardly to recover. Therefore, the afore-mentioned problem can be solved, and present invention is provided accordingly.

### FIELD OF THE INVENTION

This invention relates to a recovery device for mistaken operation of reeling door, and particularly to a recovery device which can cause the reeling door sliding downward for recovery, under the condition in which the reeling door and the latch are locked up by the mistaken operation, by a counter-potential which is caused by the reverse rotation of rotor of motor due to uprising torque happened at the moment when the sensor detects abnormality and cuts off the power supply, said counter-potential being feed back to the coil winding of the brake device to delay braking; alternatively, under the condition in which power supply is cut off by the sensor, the motor is rotated in reverse direction to make the reeling door slides downward for recovery by a reverse current temporarily supplied by a branch circuit which is sustained by the discharge action of a capacitor to a coil winding of a relay.

### SUMMARY OF THE INVENTION

The main object of this invention is to provide a recovery device for mistaken operation of reeling door, which can make the reeling door slide downward for recovery, under the condition in which the reeling door and the latch are locked up by mistaken operation, by a counter-potential which is caused by reverse rotation of rotor of motor due to uprising torque happened at the time of having abnormal condition and power supply being cut off. Said counter-potential is feed back to the coil winding of the brake device for delayed braking. In order to achieve above object, this invention comprises:

a door-reeling machine which includes a motor for driving a reel of reeling door curtain; a brake device which is provided at the inside of the door-reeling machine, which can brake the rotary shaft of the door-reeling machine by a brake disc under the condition in which the motor is not supplied with power supply, and which can actuate the brake disc to release the brake by a coil winding under the condition in which the motor is supplied with power supply. A limit switch device which includes a threaded rod moving in pace with the door-reeling machine, a pair of sliding blocks which is provided on said threaded rod for the actuation of the limit switches respectively at both ends of said threaded rod, so as to control the upper and lower dead points of the reeling door, a sensor device which includes a metal blade attached at the end of the threaded rod to follow the motion thereof, a magnetic-sensing element which is provided at the front of the rotary section of the metal blade, the reeling status of the reeling door being detected by sensing the rotary frequency of the metal blade, the power supply to the door-reeling machine being cut off by an interlock sensor when abnormal reeling condition of the door-reeling machine is detected, and a circuit for controlling the start and stop of the motor of the door reeling machine, and for controlling the braking and releasing of the brake device.

According to present invention, said circuit further includes a feedback device. The metal blade stops rotating under the condition of deadly locked-up with latch pin due to mistaken operation of reeling door. In this case, the magnetic-sensing element can sense the variation of magnetic flux so as to detect the abnormal condition and then cut off the power supply. In view of lock-up of the rotor of motor in forward direction, a counter-potential can be generated by reverse rotation of rotor of the motor due to uprising torque happened at the moment when power supply is cutting off. This counter-potential is feed back by the feedback device to a coil winding of the brake device to delay braking action, so that the reeling door can be sliding downward for recovery to its original status, and re-start after the cause of error-start is eliminated.

According to this invention, above-mentioned objects and advantages can be achieved by another application circuit. In addition to the main circuit, this application circuit includes a branch circuit which is connected to a capacitor which is charged with enough electric charge during normal operation of said main circuit. The magnetic-sensing element detects abnormal condition when reeling door is deadly locked up with latch pin due to mistaken operation, and then the interlock sensor cuts off the power supply. In this case, the capacitor discharges to a coil winding of a relay, and maintains a contact of a electromagnetic switch of the branch circuit to be closed to form a close circuit. Thus, a reverse current is supplied temporarily to motor and brake device to make the motor rotate in reverse direction, so that the reeling door slides downward to recover to its original position. The reeling door can be re-start after cause of mistaken operation of the reeling door is eliminated.

### BRIEF DESCRIPTION OF DRAWINGS

FIG. 1 is an outline schematic view of a general conventional reeling door;

FIG. 2 is a schematic view showing an embodiment of present invention applied in door-reeling machine;

FIG. 3 is a schematic view showing limit switchs disposed at upper and lower stagnation point of reeling door of present invention;

FIG. 4 is a schematic sectional view taken along with line 4-4 in FIG. 3, showing reeling status of a reeling door detected by a magnetic-sensing element;

FIG. 5 is a schematic view of one application circuit of present invention;

FIG. 6 is another schematic view of one application circuit of present invention.

### DETAILED DESCRIPTION OF A PREFERRED EMBODIMENT

The technical features of present invention will be more understood with the description in detail of a preferred embodiment of this invention, which should not be considered as limitative of this invention, in reference to the accompanied drawings.

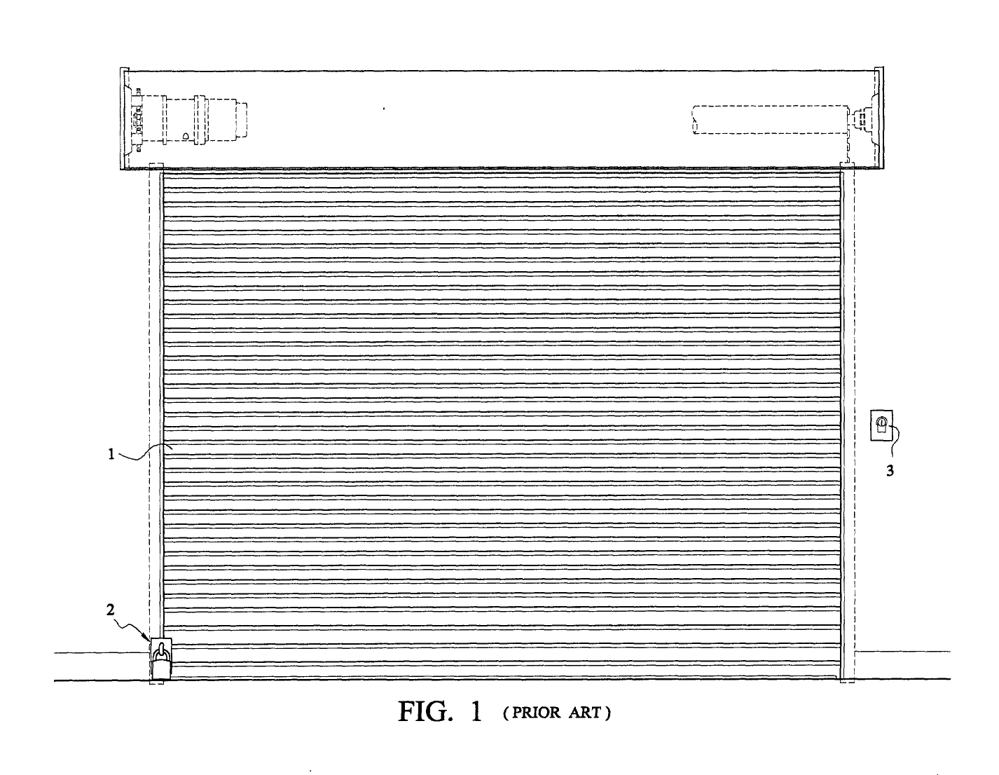

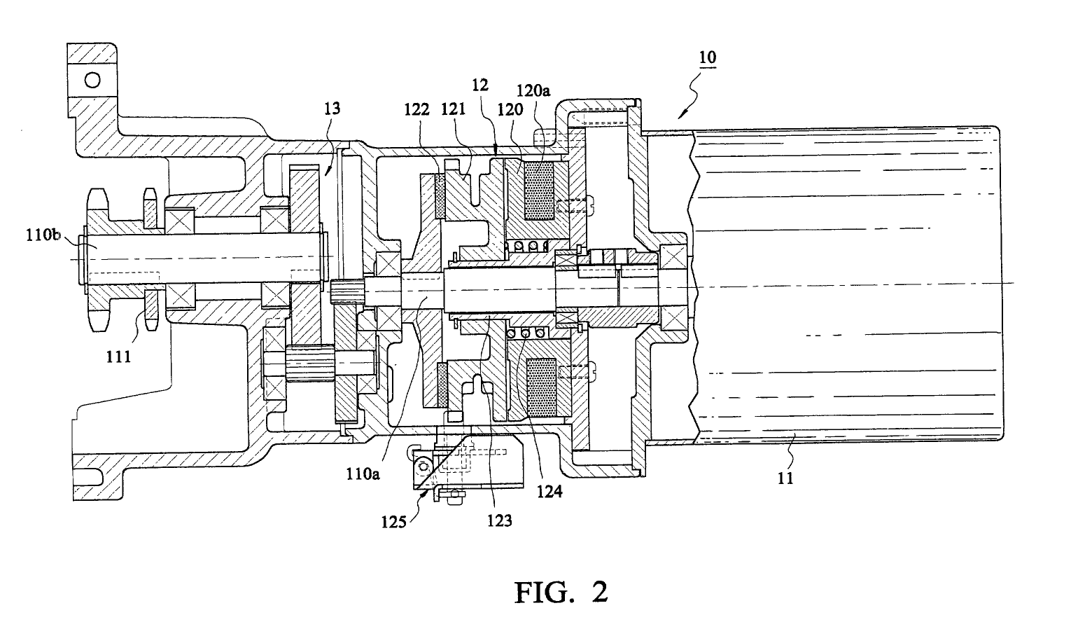

Referring to FIG. 1, the recovery device for mistaken operation of a reeling door of present invention comprises a door-reeling machine 10 which is disclosed in a publicized technique of the inventor, and one end of which is supplied with a motor 11; a brake device 12 which is provided at a lateral side of the motor 11, the center of the brake device 12 which is pivotally provided at the bush 123 of rotary shaft 110a at the power output end of the rotor of the motor 11, the brake device 12 which includes a low hysteresis electromagnet 120 fixed at the housing of the door-reeling machine 10, a brake disc 121 which is coaxially provided at the outside of the electromagnet 120, the brake disc 121 which is disposed at brake status forever by a manual operation mechanism 125, so as not to rotate in radial direction and so as to slide in axial direction only, and a brake pad 122 which is fixed at the rotary shaft 110a at the power output end of the rotor of the motor 11. The power of motor 11 is transmitted through reduction gear assembly 13 to a rotary shaft 110b at the end, for the driving of a reeling door curtain by a reel (not shown in the figure). In the case where the motor 11 is not supplied with power supply, brake disc 121 is pressed against the brake pad 122 by tension of spring 124, so that the rotary shaft 110a is braked into brake state. In the case where the motor 11 is provided with power supply, the coil winding 120a of the electromagnet 120 is also supplied with power supply at the same time, so that the brake disc 121 is attracted onto the side of electromagnet 120 to separate from the brake pad 122, so the brake is released.

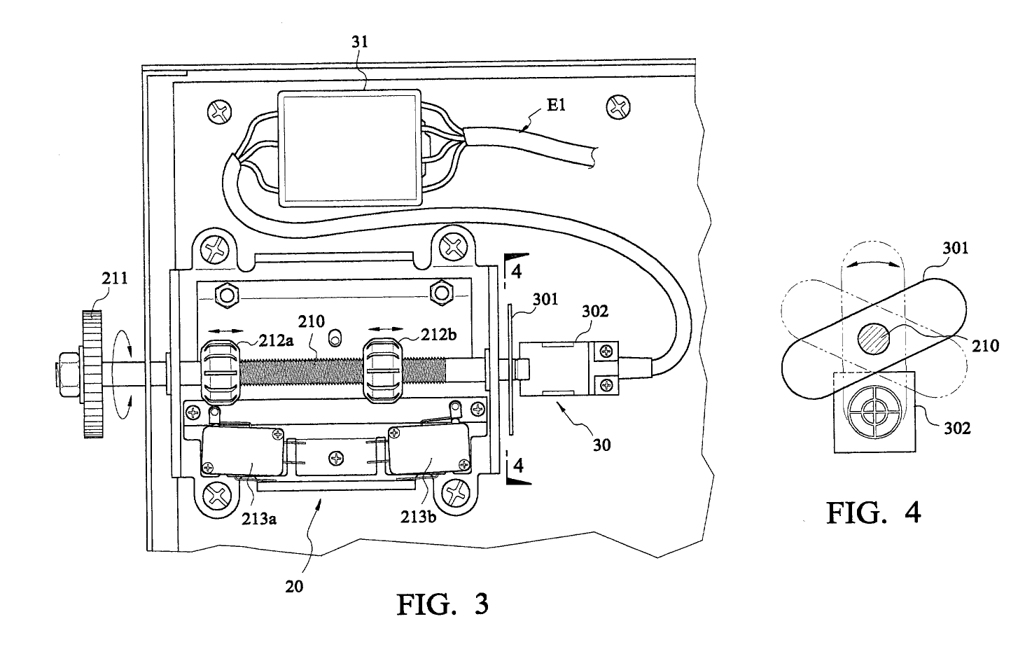

Referring to FIG. 3, according to this invention, a limit switch device 20 includes a central threaded rod 210, one end of which is provided with a gear 211 meshed with and moved with a gear 111 on the rotary shaft 110b of the door-reeling machine. A pair of sliding blocks 212a, 212b are provided on the threaded rod 210 for the actuation of the limit switches 213a, 213b respectively at both ends of the threaded rod 210 so as to control the upper and lower stagnation points of the reeling door. A sensor device 30 includes a metal blade 301 attached at another end of the threaded rod 210 of the limit switch device 20 to follow the motion of said threaded rod 210. A magnetic-sensing element 302 is provided at the front of the rotary section of the metal blade 301 (as shown in FIG. 4), the reeling status of the door-reeling machine 10 being detected by sensing the rotary frequency of the metal blade 301. The rotation frequency of the metal blade 301 at the end of the threaded rod 210 of the limit switch device 20 is changed when abnormal reeling condition of the door-reeling machine 10. For example, the door-reeling machine 10 is deadly locked up with the latch pin etc. happens. In that case, The magnetic-sensing element 302 detects the abnormal reeling state of the door-reeling machine 10 due to the change of magnetic flux, and then the interlock sensor 31 cuts off the power supply quickly.

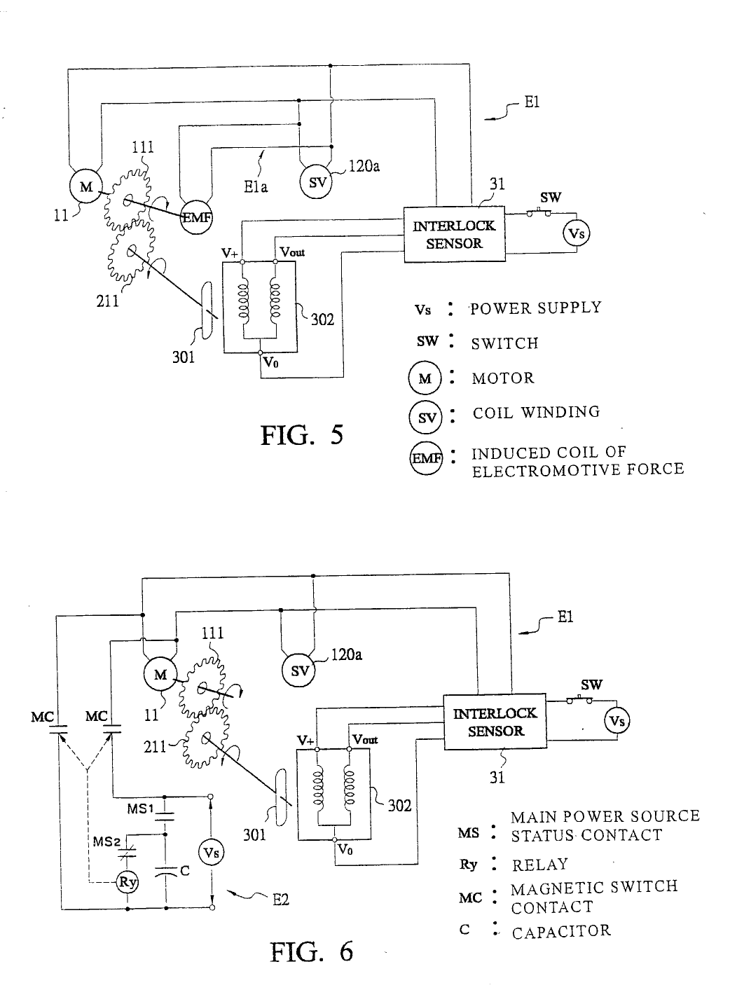

Referring to FIG. 5, according to this invention, a circuit E1 is provided for controlling start and stop of the motor 11 of the door-reeling machine 10, and controlling braking and releasing the brake device 12. The circuit further includes a feedback circuit E1a. When reeling door is deadly lock up with latch pin because of mistaken operation and because the magnetic-sensing element 302 detects this abnormal status, the interlock sensor 31 actuates to cut off the power supply. Due to the fact that the rotary shaft 110b of the door-reeling machine 10 is lock up in forward direction, the rotor of the motor 11 rotates reversely by the uprising torque at the moment when the power supply is cut off. At the same time, a counter-potential is generated by the stator in response to the cutting of magnetic flux. This counter-potential will feedback to a coil winding 120a of the electromagnet 120 of the brake device 12 by the feedback circuit E1a to delay the braking, so that the iron reeling door slides downwardly to recover. Thus, the switch of the iron reeling door can be restart after the cause of mistaken operation is eliminated.

In addition, another application circuit is shown in FIG. 6. In this embodiment, a branch circuit E2 is provided other than the main circuit E1. The branch circuit E2 is in open state when the main circuit E1 is in normal operation. The branch circuit E2 is coupled with a capacitor C, which can be charged with enough electric charge through the normal-open contact MS1 of the main circuit E1 during normal operation of the main circuit E1. The magnetic-sensing element 302 detects abnormal condition when reeling door is deadly locked up with latch pin due to mistaken operation, and then the interlock sensor 31 cuts off the power supply. In this case, the capacitor C discharges to a coil winding of a relay RY through a normally closed contact MS2 of the main circuit E1, and making a normally opened contact MC of a electromagnetic switch of the branch circuit E2 to be closed to form a close circuit. Thus, a reverse current Vs is supplied temporarily to motor 11, and the coil winding 120a of the electromagnet 120 of the brake device makes the motor 11 rotate in reverse direction, so that the reeling door slides downward to recover to its original position. The reeling door can be restart after the elimination of the cause of mistaken operation of the reeling door.

Alternatively, based on the same view, when the magnetic-sensing element 302 detects abnormal condition and then the interlock sensor 31 cuts off the power supply, the capacitor C discharges to a coil winding of a relay RY through a normally closed contact MS2 of the main circuit E1, and making a normally opened contact MC of a electromagnetic switch of the branch circuit E2 to be closed to form a close circuit. Thus, a reverse current Vs is supplied temporarily to the coil winding 120a of the electromagnet 120 of the brake device 12 to delay braking action (this part is not illustrated in the Figures, and is the application of the same principle). Thus, the reeling door slides downward to recover to its original position due to the reverse rotation of rotor of the motor by uprising torque to achieve the same effect as above.

The above-mentioned herein in merely a preferred embodiment of present invention, and shouldn't be regarded as a limitation of present invention. Various equivalent modifications and variations are within the scope of present invention without departing to the scope of the appended claims of this invention.

Summing up above, the recovery device for mistaken operation of reeling door of present invention can achieve the effectiveness of recovery without any additional increase in cost expense, even if it is locked up with latch pin due to mistaken operation. Therefore, this invention is a novel and progressive invention which has valuable industrial availability.

### LIST OF REFERENCE NUMERALS

| | |
|---|---|
| 10 | door-reeling machine |
| 11 | motor |
| 110a, 110b | rotary shaft |
| 111 | gear |
| 12 | brake device |
| 120 | electromagnet |
| 120a | coil winding |
| 121 | brake disc |
| 122 | brake pad |
| 123 | bush |
| 124 | spring |
| 125 | manual operation mechanism |
| 13 | reduction gear assembly |
| 20 | limit switch device |
| 210 | threaded rod |
| 211 | gear |
| 212a, 212b | sliding block |
| 213a, 213b | limit switch |
| 30 | sensor device |
| 301 | metal blade |
| 302 | magnetic-sensing device |
| 31 | interlock sensor |

What is claimed is:

1. A recovery device for mistaken operation of reeling door, characterized in that it comprises:
a door-reeling machine (10), which includes a motor (11) for driving a reel of the reeling door;
a brake device (12), which is provided at the inside of the door-reeling machine (12) for the braking of a rotary shaft (110), and which can actuate the brake disc (121) to release the brake by a coil winding (120a) under energizing condition of said motor (11);
a limit switch device (20), which includes a threaded rod (210) moving in pace with the door-reeling machine (10), and a pair of sliding blocks (212a, 212b) that are provided on said threaded rod (210) for the actuation of the limit switches (213a,213b) respectively at both ends of said threaded rod (210) so as to control the upper and lower dead points of the reeling door;
a sensor device (30) which detects reeling status of said door-reeling machine (10), the power supply supplied to said door-reeling machine (10) being cut off when abnormal reeling condition of said reeling door is detected;
a circuit (E1), which is provided for controlling start and stop of the motor (11) of the door-reeling machine (10), and for controlling braking and releasing of the brake device (12), said circuit (E1) further including a feedback circuit (E1a), in which when said sensing device detects this abnormal status then cuts off the power supply, the rotor of said motor (11) rotates reversely by uprising torque, and a counter-potential is generated which is then feedback to the coil winding (120a) of said brake device (12) to delay the braking, so that said iron reeling door slides downward to recover.

2. A recovery device for mistaken operation of reeling door, characterized in that it comprises:
a door-reeling machine (10), which includes a motor (11) for driving a reel of the reeling door;
a brake device (12), which is provided at the inside of the door-reeling machine (12) for the braking of a rotary shaft (110), and which can actuate the brake disc (121) to release the brake by a coil winding (120a) under the condition where said motor (11) is supplied with power supply;
a limit switch device (20), which includes a threaded rod (210) moving in pace with the door-reeling machine (10), a pair of sliding blocks (212a,212b) that are provided on said threaded rod (210) for the actuation of the limit switches (213a,213b) respectively at both ends of said threaded rod (210) so as to control the upper and lower dead points of the reeling door;
a sensor device (30) which can detect reeling status of said door-reeling machine (10), the power supply supplied to said door-reeling machine (10) being cut off when abnormal reeling condition of said reeling door is detected;
a circuit (E1), which is provided for controlling start and stop of the motor (11) of the door-reeling machine (10), and for controlling braking and releasing of the brake device (12); said circuit (El) further including a branch circuit (E2) connected with a capacitor (C), in which when said sensing device detects this abnormal status and then cuts off the power supply, said capacitor (C) discharges to a coil winding of a relay (RY) so as to maintain said branch circuit temporarily supplying a reverse current, to make the motor (11) rotate in reverse direction, so that the reeling door slides downward to recover to its original position.

3. A recovery device for mistaken operation of reeling door in accordance with claim 1, wherein said sensor device (30) includes a metal blade (301) attached at another end of the threaded rod (210) of the limit switch device (20) to follow the motion therefrom.

4. A recovery device for mistaken operation of reeling door in accordance with claim 3, wherein said sensor device (30) includes a magnetic-sensing element (302) provided at the front of rotary section of said metal blade (301).

5. A recovery device for mistaken operation of reeling door in accordance with claim 1, wherein the coil winding of said brake device (12) is the coil winding (120a) of a electromagnet (120).

6. A recovery device for mistaken operation of reeling door in accordance with claim 2, wherein said circuit (E1) further includes a branch circuit (E2) connected with a capacitor (C), in which when said sensing device detects an abnormal status and cuts off the power supply, said capacitor (C) discharges to a coil winding of a relay (RY) so as to maintain said branch circuit temporarily supplying a reverse current (Vs) to said coil winding (120a) of the electromagnet (120) of the brake device (12) to delay braking action, so as to make said reeling door slide downward to recover to its original position due to uprising torque.

7. A recovery device for mistaken operation of reeling door in accordance with claim 2, wherein said sensor device (30) includes a metal blade (301) attached at another end of the threaded rod (210) of the limit switch device (20) to follow the motion therefrom.

8. A recovery device for mistaken operation of reeling door in accordance with claim 7, wherein said sensor device (30) includes a magnetic-sensing element (302) provided at the front of rotary section of said metal blade (301).

9. A recovery device for mistaken operation of reeling door in accordance with claim 2, wherein the coil winding of said brake device (12) is the coil winding (120a) of an electromagnet (120).
